(19) United States
(12) Patent Application Publication
(10) Pub. No.: US 2025/0016756 A1
(43) Pub. Date: Jan. 9, 2025

(54) METHOD FOR WAVEFORM SWITCHING, DEVICE, AND READABLE STORAGE MEDIUM

(71) Applicant: VIVO MOBILE COMMUNICATION CO., LTD., Dongguan (CN)

(72) Inventors: Xueming PAN, Dongguan (CN); Zichao JI, Dongguan (CN); Kai WU, Dongguan (CN); Rakesh TAMRAKAR, Dongguan (CN); Siqi LIU, Dongguan (CN); Can LI, Dongguan (CN); Yi GU, Dongguan (CN)

(73) Assignee: VIVO MOBILE COMMUNICATION CO., LTD., Dongguan (CN)

(21) Appl. No.: 18/892,668

(22) Filed: Sep. 23, 2024

Related U.S. Application Data
(63) Continuation of application No. PCT/CN2023/083052, filed on Mar. 22, 2023.

(30) Foreign Application Priority Data
Mar. 23, 2022 (CN) 202210304852.4

(51) Int. Cl. H04W 72/0453; H04W 72/232

(52) U.S. Cl. CPC H04W 72/0453; H04W 72/232

(57) ABSTRACT

This application discloses a method for waveform switching, a device, and a chip. The method includes: The terminal receives a first downlink control information (DCI) from a network device, where the first DCI is used to schedule physical channels of a plurality of cells; and the terminal uses pre-configured waveforms of the physical channels of the plurality of cells, where when the first DCI is used to schedule the physical channels of the plurality of cells, the terminal does not support dynamic waveform switching.

### CROSS-REFERENCE TO RELATED APPLICATIONS

This application is a continuation of International Application No. PCT/CN2023/083052, filed Mar. 22, 2023, which claims priority to Chinese Patent Application No. 202210304852.4, filed Mar. 23, 2022. The entire contents of each of the above-referenced applications are expressly incorporated herein by reference.

### TECHNICAL FIELD

This application relates to the field of communication technologies, and in particular, to a method for waveform switching, a device, and a readable storage medium.

### BACKGROUND

Currently, waveform switching is implemented in a semi-static manner. In a case that Radio Resource Control (RRC) reconfiguration is not performed, transmission can only be performed based on an existing waveform configuration with a slow update rate and an ineffective enhancement of transmission performance.

### SUMMARY

Embodiments of this application provide a method for waveform switching, a device, and a readable storage medium.

According to a first aspect, a method for waveform switching is provided. The method includes the following steps.

A terminal receives first DCI from a network device, where the first DCI is used to schedule physical channels of a plurality of cells.

In a case that the first DCI carries first indication information, the terminal switches, based on the first indication information, waveforms of the physical channels of the plurality of cells according to a preset rule, where the preset rule is associated with an attribute of the plurality of cells.

In some embodiments, the terminal uses pre-configured waveforms of the physical channels of the plurality of cells.

According to a second aspect, an apparatus for waveform switching is provided, including:
a receiving module, configured to receive first DCI from a network device, where the first DCI is used to schedule physical channels of a plurality of cells; and
a processing module, configured to: in a case that the first DCI carries first indication information, switch based on the first indication information, waveforms of the physical channels of the plurality of cells according to a preset rule, where the preset rule is associated with an attribute of the plurality of cells; or
the terminal uses pre-configured waveforms of the physical channels of the plurality of cells.

According to a third aspect, a terminal is provided. The terminal includes a processor and a memory, the memory stores a program or an instruction that can be run on the processor, and the program or the instruction is executed by the processor to implement the steps of the method according to the first aspect.

According to a fourth aspect, a terminal is provided, including a processor and a communication interface. The communication interface is configured to receive, by the terminal, a first DCI from a network device, where the first DCI is used to schedule physical channels of a plurality of cells. The processor is configured to: in a case that the first DCI carries first indication information, switch based on the first indication information, waveforms of the physical channels of the plurality of cells according to a preset rule, where the preset rule is associated with an attribute of the plurality of cells; or the terminal uses pre-configured waveforms of the physical channels of the plurality of cells.

According to a fifth aspect, a readable storage medium is provided. The readable storage medium stores a program or an instruction, and the program or the instruction is executed by a processor to implement the steps of the method according to the first aspect.

According to a sixth aspect, a chip is provided. The chip includes a processor and a communication interface, where the communication interface is coupled to the processor, and the processor is configured to run a program or an instruction to implement the method according to the first aspect.

According to a seventh aspect, a computer program/program product is provided. The computer program/program product is stored in a storage medium, and the computer program/program product is executed by at least one processor to implement the steps of the method according to the first aspect.

In the embodiments of this application, in a case that the terminal receives DCI for scheduling the physical channels of the plurality of cells, the terminal switches, based on an indication carried in the DCI, the waveforms of the physical channels of the plurality of cells according to the preset rule associated with the attribute of the plurality of cells, to implement dynamic waveform switching, thereby effectively ensuring transmission performance of a UE.

### BRIEF DESCRIPTION OF DRAWINGS

FIG. 1 is a schematic diagram of an architecture of a wireless communication system according to an embodiment of this application;

FIG. 2 is a flowchart of a method for waveform switching according to an embodiment of this application;

FIG. 3 is a schematic diagram of a structure of an apparatus for waveform switching according to an embodiment of this application;

FIG. 4 is a schematic diagram of a structure of a communication device according to an embodiment of this application; and

FIG. 5 is a schematic diagram of a structure of a terminal according to an embodiment of this application.

### DETAILED DESCRIPTION

The following clearly describes the technical solutions in embodiments of this application with reference to the accompanying drawings in the embodiments of this application. Apparently, the described embodiments are some but not all of the embodiments of this application. All other embodiments obtained by a person of ordinary skill in the art based on the embodiments of this application shall fall within the protection scope of this application.

The terms “first”, “second”, and the like in this specification and claims of this application are used to distinguish between similar objects instead of describing a specific order or sequence. It should be understood that, the terms used in such a way are interchangeable in proper circumstances, so that the embodiments of this application can be implemented in an order other than the order illustrated or described herein. Objects classified by “first” and “second” are usually of a same type, and the number of objects is not limited. For example, there may be one or more first objects. In addition, in this specification and the claims, “and/or” represents at least one of connected objects, and a character “/” generally represents an “or” relationship between associated objects.

It should be noted that technologies described in the embodiments of this application are not limited to a Long Time Evolution (LTE)/LTE-Advanced (LTE-A) system, and may further be applied to other wireless communication systems such as Code Division Multiple Access (CDMA), Time Division Multiple Access (TDMA), Frequency Division Multiple Access (FDMA), Orthogonal Frequency Division Multiple Access (OFDMA), Single-carrier Frequency Division Multiple Access (SC-FDMA), and other systems. The terms “system” and “network” in the embodiments of this application may be used interchangeably. The technologies described can be applied to both the systems and the radio technologies mentioned above as well as to other systems and radio technologies. A New Radio (NR) system is described in the following description for illustrative purposes, and the NR terminology is used in most of the following description, although these technologies can also be applied to applications other than the NR system application, such as the 6^{th} generation (6G) communication system.

FIG. 1 is a block diagram of a wireless communication system to which the embodiments of this application may be applied. The wireless communication system includes terminals 11 and a network side device 12. The terminal 11 may be a terminal-side device such as a mobile phone, a tablet personal computer, a laptop computer or a notebook computer, a personal digital assistant (PDA), a palmtop computer, a netbook, an ultra-mobile personal computer (UMPC), a mobile Internet device (MID), an augmented reality (AR)/virtual reality (VR) device, a robot, a wearable device, vehicle user equipment (VUE), pedestrian user equipment (PUE), a smart home (a home device with a wireless communication function, such as a refrigerator, a television, a washing machine, or furniture), a game console, a personal computer (PC), a teller machine, or a self-service machine. The wearable device includes a smart watch, a smart band, a smart headset, smart glasses, smart jewelry (a smart bracelet, a smart chain bracelet, a smart ring, a smart necklace, a smart anklet, or a smart chain anklet), a smart wrist strap, smart clothing, and the like. It should be noted that a specific type of the terminal 11 is not limited in the embodiments of this application. The network side device 12 may include an access network device or a core network device. The access network device may also be referred to as a radio access network device, a Radio Access Network (RAN), a radio access network function, or a radio access network unit. The access network device may include a base station, a Wireless Local Area Network (WLAN) access node, a Wireless Fidelity (Wi-Fi) node, or the like. The base station may be referred to as a NodeB, an evolved NodeB (eNB), an access point, a Base Transceiver Station (BTS), a radio base station, a radio transceiver, a Basic Service Set (BSS), an Extended Service Set (ESS), a home NodeB, a home evolved NodeB, a Transmitting Receiving Point (TRP), or another appropriate term in the art. As long as a same technical effect is achieved, the base station is not limited to a specified technical term. It should be noted that, in the embodiments of this application, only a base station in an NR system is used as an example, but a specific type of the base station is not limited.

For better understanding of the solution provided in this application, the following content is described first:

### 1. Existing Waveform Indication Manner and Possible Switching Manner

In the conventional technology, a transmission waveform of a common Physical Uplink Shared Channel (PUSCH) and a transmission waveform of a PUSCH for message 3 (MSG3) transmission are respectively configured by using a physical uplink shared channel configuration (Physical Uplink Shared Channel-config, PUSCH-config) and a random access channel common configuration (Random Access Channel-ConfigCommon, RACH-ConfigCommon). The waveforms of the common PUSCH and the MSG3 PUSCH are updated only in a case where Radio Resource Control (RRC) is reconfigured. It is assumed that a PUSCH scheduled by Downlink Control Information (DCI) 0_0 is an MSG3 PUSCH transmission, in which a Discrete Fourier Transform-Spread Orthogonal Frequency Division Multiplexing (DFT-S-OFDM) waveform is used; and a PUSCH scheduled by DCI 0_1 is a common PUSCH transmission, in which a cyclic prefix orthogonal frequency division multiplexing (cyclic prefix-OFDM, CP-OFDM) waveform is used. Then, a potential waveform switching may be implemented by using different pieces of scheduling DCI. However, strictly speaking, in this manner, two types of PUSCHs of the same User Equipment (UE) are transmitted by using different waveforms, and cannot be considered as dynamic waveform switching.

### 2. PUSCH Uplink Frequency Domain Resource Assignment Manner and Indication Manner

In NR, PUSCH uplink frequency domain resource assignment supports three assignment manners: type 0, type 1, and type 2. A difference lies in that type 0 only supports transform precoding disabled, while type 1 and type 2 support transform precoding enabled or disabled. A specific transmission mode is controlled through a parameter resourceAllocation.

In a case that a value is dynamicSwitch, it means that the frequency domain resource assignment manner is controlled by using DCI. Principles are as follows:

(1) If DCI Format 0_1 is used, and a frequency domain resource assignment field is set to ‘dynamicSwitch’; or if DCI Format 0_2 is used, and a resourceAllocation-ForDCIFormat0_2 field is set to ‘dynamicswitch’, then type 0 and type 1 are used for uplink resource assignment, which are selected based on a specific DCI setting field.

(2) If DCI format 0_0 is used, then the assignment mode of type 1 is used.

(3) If DCI format 0_1 is used and useInterlacePUSCH-Dedicated is set to ‘enabled’, then the assignment mode of type 2 is used.

(4) If useInterlacePUSCH-Common or useInterlacePUSCH-Dedicated is set to ‘enabled’, then the assignment mode of type 2 is used.

Because type 2 relates to a resource assignment manner of NR in unlicensed band (NRU), type 2 is not currently involved in this application.

### Type 0:

Resource assignment information includes bitmap information indicating a specific resource block group (RBG) to a scheduling UE, and the RBG includes a group of contiguous virtual Physical Resource Blocks (PRBs), and is a flexible resource assignment manner. The UE determines, based on an indication per RBG, whether each RBG is used for transmission.

### Type 1:

Resource assignment includes contiguous resource indicator values (RTVs), and is a contiguous resource assignment manner, in which a quantity of PRBs that are finally mapped is determined based on an indication of RIV

### Dynamic:

Dynamic has been described above and is equivalent to determining a specific frequency domain resource assignment based on a type of the DCI and a size of the DCI. In this background, in a case that a Frequency Domain Resource Assignment (FDRA) domain is configured as dynamic at RRC level, sufficient DCI bits need to be reserved to complete indication.

### 3. Group Common DCI

Group common DCI may be referred to as group DCI (or referred to as group common DCI). The group DCI mainly includes a format of a format 2 series. A base station configures indication information for a part of UEs by using the group DCI, so that the part of UEs simultaneously implements scheduling indication. In a transmission process, the group DCI is configured with different sizes based on different formats. Generally, a size is determined based on a setting of a higher layer or a quantity of bits monitored by a Common Search Space (CSS), or may be aligned with fallback DCI. For example, a size of DCI 2-2 needs to be not greater than a size of DCI format 1_0. In a case that the size of DCI 2-2 is smaller than the size of DCI 1_0, 0 needs to be supplemented until the size of DCI 2-2 is equal to the size of DCI format 1_0.

### 4. Configured Scheduling PUSCH

Dynamic grant (DG) scheduling is a common manner of a communication system. During actual application, in a case that a user has a large quantity of data to be sent and transmitted, and a network can predict a continuous resource requirement of the user in a future period, dynamic scheduling consumes some signaling resources. In this case, an advantage of a non-dynamic scheduling manner is highlighted. In a protocol, a PUSCH that uses configured grant (CG) scheduling (configured scheduling) performs this feature. PUSCHs transmitted need to be periodically sent, and a Transport Block (TB) needs to be actually transmitted in a scheduled resource. Otherwise, a ULE does not send data on the resource. The configurable scheduling has two types: type 1 and type 2. The following describes the two transmission modes.

### Type 1:

Transmission-related parameters of a CG-Type 1 PUSCH are configured by using RRC and are not activated or deactivated by using any DCI. A specific RRC parameter setting for configured scheduling is shown. For the Type 1 CG-PUSCH, all parameters (except power) are configured through a higher layer with no additional indication required, and the RRC is not required for activation and deactivation processing. Because this process does not require scheduling, it is also referred to as a grant-free scheduling process.

### Type 2:

A part of transmission-related parameters of a CG-Type 2 PUSCH are configured by using RRC, and the other part of the transmission-related parameters are configured by using DCI which undertakes an activation function. As shown in the foregoing figure, unlike Type 1, a ConfiguredUplinkGrant part is not configured by using RRC, but is indicated by using DCI. The DCI is generally format 00, 01, or 0_2, and is checked by using a CRC-scrambled Configured Scheduling Radio Network Temporary Identity (CS-RNTI) configured by means of CRC scrambling. A specific process is as follows:

(1) A ULE receives DCI and the DCI may be descrambled by using the CS-RNTI.

(2) A related domain of the DCI is designed as follows.

A design of an activated DCI field is shown in Table 1.

TABLE 1

| | DCI format 0_0/0_1/0_2 |
|---|---|
| Hybrid Automatic Repeat Request (HARQ) | set to all ‘0’s |
| process number | |
| Redundancy version | set to all ‘0’s |

A design of a deactivated DCI field is shown in Table 2.

| | DCI format 0_0/0_1/0_2 |
|---|---|
| HARQ process number | set to all ‘0’s |
| Redundancy version | set to all ‘0’s |
| Modulation and coding scheme | set to all ‘1’s |
| Frequency domain resource assignment | set to all ‘0’s for |
| | FDRA Type 2 with μ = 1 |

The above is a design manner for a single CG-type 2 PUSCH configuration. If activation and deactivation are performed on a plurality of CG-type 2 PUSCH configurations, a HARQ process number is not set as above. The HARQ process number is used to determine, based on whether ConfiguredGrantConfigType2DeactivationStateList is configured, whether to deactivate a quantity of CG-type 2 PUSCHs or a sequence number corresponding to the CG-type 2 PUSCHs.

### 5. Relationship Between Rank and Waveform

A rank represents a quantity of layers that can be transmitted in an uplink transmission. A DFT-s-OFDM waveform has a function of reducing Peak to Average Power Ratio (PAPR) and may eliminate the need to back off excessive power in a case of non-linearity or overload distortion caused by a prolonged full-power transmission. Therefore, the DFT-s-OFDM waveform has an advantage in a case that a full-power transmission power is needed for sending. It is generally considered that the DFT-s-OFDM waveform is used only in a case in which the rank is 1. Rank=1 indicates that a channel is deteriorated. In this case, to ensure transmission reliability, the DFT-s-OFDM waveform has a greater advantage. For a scenario in which rank is greater than 1, a channel condition is generally considered as good. In this case, a CP-OFDM waveform is generally used for transmission to increase a transmission rate, and transmission using the DFT-s-OFDM waveform does not make much sense. Therefore, a DFT whose rank is greater than 1 is not configured in an existing protocol. Therefore, the rank has a potential to indicate a waveform.

### 6. Carrier Aggregation (CA) and Cross-Carrier Scheduling

In carrier aggregation (CA), two or more Component Carriers (CCs) are aggregated. A UE can simultaneously receive and/or transmit on one or more CCs based on its capability:

(1) A UE with single timing advance capability for CA can simultaneously receive and/or transmit on a plurality of CCs corresponding to a plurality of serving cells sharing the same timing advance (a plurality of serving cells grouped in one Timing Advance Group (TAG)).

(2) A UE with a plurality of timing advance capabilities for CA can simultaneously receive and/or transmit on a plurality of CCs corresponding to a plurality of serving cells with different timing advances (a plurality of serving cells grouped in a plurality of TAGs). NG-RAN ensures that each TAG contains at least one service unit.

(3) A non-CA capable UE can receive on a single CC and transmit on a single CC corresponding to one serving cell only (one serving cell in one TAG).

Both continuous and discontinuous CCs support CA. In a case that CA is deployed, frame timing and System Frame Number (SFN) are aligned between cells that can be aggregated, or offset of a plurality of slots between a Primary Cell (PCell)/Primary Secondary Cell (PSCell) and a secondary cell is configured for the UE. A maximum quantity of CCs configured for the UE is 16 (downlink (DL)) and 16 (uplink (UL)).

Activation and deactivation of a carrier may be performed by Medium Access Control (MAC) signaling including a bitmap, where each bit indicates whether a configured SCell is in an active state.

Cross-carrier scheduling with a Carrier Indicator Field (CIF) allows a physical downlink control channel (PDCCH) (DCI x_1/2) of a serving cell to schedule a resource in another serving cell, but with the following limitations.

(1) Cross-carrier scheduling is not applicable to a PCell, that is, the PCell is always scheduled by using a PDCCH of the PCell.

(2) In a case that a PDCCH is configured for an SCell, a PDSCH and a PUSCH of the cell are always scheduled by using a PDCCH on the SCell.

(3) In a case that no PDCCH is configured for the SCell, the PDSCH and the PUSCH of the SCell are always scheduled by using a PDCCH on another serving cell.

(4) The scheduling PDCCH and the scheduling PDSCH/PUSCH may use the same or different digits.

### 7. Multi-Cell PUSCH Scheduling

Enhancements with DC/CA (dual connection/carrier aggregation) are as follows:

Multi-cell PUSCH/PDSCH scheduling based on a single piece of DCI (FR1 and FR2) (one PDSCH/PUSCH per cell).

### 8. Timing Advance Group (TAG)

In an RRC_CONNECTED state, a gNB is responsible for keeping a timing advance to maintain L1 synchronization. One TAG includes a serving cell that applies the same timing advance UL and uses the same timing reference cell. Each TAG includes at least one serving cell configured with an uplink. A mapping from each serving cell to the TAG is configured by RRC.

In the conventional technology, a UE has a capability of sending multi-stream data in a CP-OFDM waveform, and a network tends to configure the UE to be in a CP-OFDM waveform for a PUSCH transmission, so as to obtain a faster data rate. However, in a case that a capability of the UE is not sufficient to support a multi-stream transmission (for example, to a cell edge), the UE will continue to transmit using the CP-OFDM waveform unless an RRC reconfiguration occurs. Because a PAPR indicator of the CP-OFDM waveform is high, a power amplifier has to perform power backoff during a transmission, resulting in a transmission power loss, which affects PUSCH transmission performance of the UE.

To improve transmission performance of an edge user of a cell, the UE needs to support dynamic waveform switching to be able to use the CP-OFDM waveform with a higher transmission rate in a case that a channel condition is good and to switch back to a DFT-s-OFDM waveform at the edge of the cell, thereby effectively ensuring transmission performance of the UE. In the conventional technology, it is not specified as to a manner in which waveform switching is indicated. For a waveform switching manner indicated by using DCI, a specific indication mechanism needs to be improved, so as to ensure that waveform switching or target waveform indication may be completed by using a reasonable indication, whether it is a PUSCH or a PUCCH of DG or CG. Therefore, a perfect indication manner needs to be designed to implement dynamic indication of waveform switching. In a case of carrier aggregation, a plurality of factors need to be further considered in how to implement dynamic waveform indication and in what cases waveform switching needs to be performed.

With reference to the accompanying drawings, a method for waveform switching provided in the embodiments of this application is described in detail by using some embodiments and application scenarios thereof.

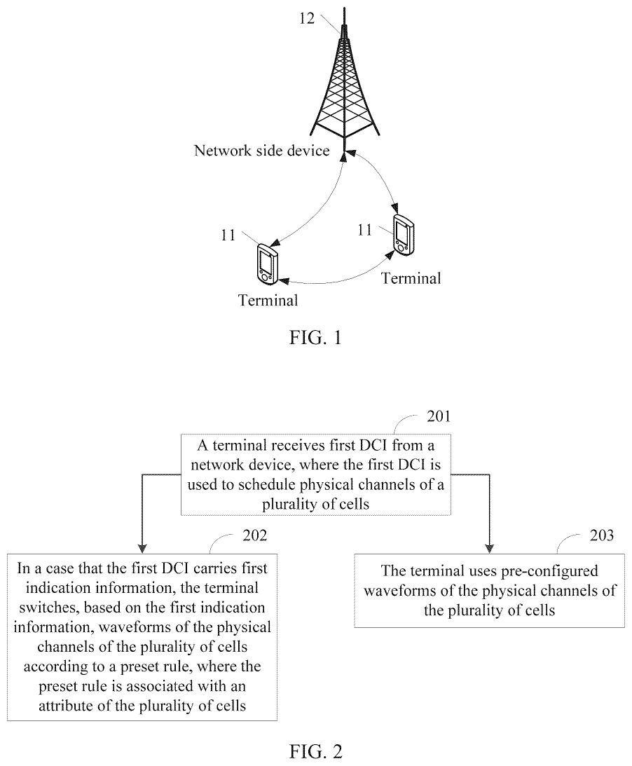

Refer to FIG. 2. An embodiment of this application provides a method for waveform switching. The method includes the following steps.

Step 201: A terminal receives first DCI from a network device, where the first DCI is used to schedule physical channels of a plurality of cells, and then performs step 202 or step 203.

Step 202: In a case that the first DCI carries first indication information, the terminal switches, based on the first indication information, waveforms of the physical channels of the plurality of cells according to a preset rule, where the preset rule is associated with an attribute of the plurality of cells.

Step 203: The terminal uses pre-configured waveforms of the physical channels of the plurality of cells.

It should be noted that the physical channels of the plurality of cells each may be a Physical Uplink Shared Channel (PUSCH), a Physical Uplink Control Channel (PUCCH), a Physical Sidelink Shared Channel (PSSCH), a Physical Sidelink Control Channel (PSCCH), or a Physical Downlink Shared Channel (PUSCH). A specific type of the physical channel is not limited in the embodiments of this application. For convenience, a case in which the physical channels each are the PUSCH is used as an example for description in the following specific description process of the embodiments.

The waveform switching manner described in step 201 may be understood that dynamic waveform switching (DWS) is performed as instructed by the first DCI. Therefore, the foregoing waveform switching performed according to the preset rule may also be referred to as DWS.

It should be noted that the foregoing waveform switching may refer to switching between the CP-OFDM waveform and the DFT-s-OFDM waveform. In some embodiments, in a case that there is another type of waveform, the foregoing waveform switching may also refer to switching a current waveform to a target waveform.

The pre-configured waveforms of the physical channels of the plurality of cells described in step 202 refer to existing semi-statically configured waveforms. In other words, it may be understood that in a case that a plurality of PUSCHs are scheduled for a single piece of DCI, DWS is not supported. That is, in a case that the first DCI is used to schedule the physical channels of the plurality of cells, the terminal does not support dynamic waveform switching.

For the execution manner described in step 202, scheduling a multi-cell by using the first DCI may be considered as information that indirectly indicates that DWS is not performed.

The advantage of using the execution manner of step 202 is that DWS is not performed, which means that bits that are in a DCI format and that are used to indicate DWS may be used to indicate related information about multi-cell physical channel scheduling.

In this embodiment of this application, in a case that the terminal receives DCI for scheduling the physical channels of the plurality of cells, the terminal switches, based on an indication carried in the DCI, the waveforms of the physical channels of the plurality of cells according to the preset rule associated with the attribute of the plurality of cells, to implement dynamic waveform switching, thereby effectively ensuring transmission performance of a UE.

In a possible implementation, the attribute of the plurality of cells includes one or more of the following:

(1) a relationship among the plurality of cells on a frequency domain resource, such as a carrier aggregation manner of the cells is intra-band carrier aggregation or inter-band carrier aggregation;

(2) a frequency domain resource assignment manner of the physical channels of the plurality of cells (that is, associated with FDRA);

(3) a time domain resource assignment relationship of the physical channels of the plurality of cells (that is, associated with Time Domain Resource Assignment (TDRA));

(4) a Bandwidth Part (BWP) in which the physical channels of the plurality of cells are located; and

(5) whether the plurality of cells belong to a same TAG.

The following describes a specific manner of DWS with reference to an attribute of a specific cell.

Case 1: In a possible implementation, in a case that the plurality of cells include one or more cell groups, and intra-band carrier aggregation is used between a plurality of cells in each cell group, the terminal switches, based on the first indication information, waveforms of the physical channels of the plurality of cells according to a preset rule includes one or more of the following:

(1) The terminal switches, based on the first indication information, waveforms of physical channels of all cells in the cell group to a same waveform, where the first indication information is used to indicate whether to switch waveforms of physical channels of different cells in the cell group.

In this embodiment of this application, DWS configuration occurs in each cell of the cell group, and a network ensures that there is no different waveform between a plurality of PUSCHs scheduled by the first DCI in the cell group. During specific implementation, the first indication information may include a plurality of bits, and each bit corresponds to indicating whether a cell performs DWS.

(2) The terminal switches, based on the first indication information, a waveform of a physical channel of a first cell in the cell group to the same as a waveform of a physical channel of a second cell in the cell group, where the first cell is a cell in the cell group except the second cell, and the first indication information is used to indicate whether to switch the waveform of the physical channel of the first cell.

In this embodiment of this application, DWS is determined by a waveform of a PUSCH of a specific cell (that is, the second cell) in the cell group. In a case that a waveform configured for the first cell in the cell group is different from the waveform of the PUSCH of the specific cell, DWS is performed on the PUSCH of the first cell; otherwise, DWS is not performed. This is to ensure that PUSCHs of all the cells in the group have a same waveform.

In some embodiments, the second cell is configured by a network side, for example, configured by RRC signaling, MAC signaling, and DCI signaling, or the second cell is stipulated in a protocol, for example, a cell with a smallest Physical Cell Identifier (PCI) in a multi-cell PUSCH.

During specific implementation, DWS may be performed on an entire cell group. For example, for each cell group, one-bit signaling is used to indicate whether to simultaneously switch to the DFT-s-OFDM waveform or to the CP-OFDM waveform.

In a possible implementation, in a case that the multi-cell PUSCH has a plurality of layers for transmission, all PUSCHs in the DFT-s-OFDM waveform is switched to the CP-OFDM waveform. The second cell in (2) above is a cell that transmits a PUSCH on the plurality of layers.

Case 2: In a case that the plurality of cells include one or more cell groups, and inter-band carrier aggregation is used between a plurality of cells in each cell group, the terminal switches, based on the first indication information, waveforms of the physical channels of the plurality of cells according to a preset rule includes one or more of the following.

(1) In a case that the plurality of cells include one cell group, independently determining, by the terminal based on the first indication information, whether to switch a waveform of a physical channel of each cell in the cell group, where the first indication information is used to indicate whether to switch waveforms of physical channels of different cells in the cell group.

In this embodiment of this application, DWS occurs in each cell of the cell group, so that there is independent waveform switching between a plurality of PUSCHs scheduled by the DCI in the cell group. During specific implementation, one bit is used in the first indication information to indicate switching for each cell, or an indication bit is jointly encoded with TDRA, FDRA, or the like.

(2) In a case that the plurality of cells include a plurality of cell groups, the terminal separately switches, based on the first indication information, waveforms of physical channels of all cells in each cell group, where the first indication information is used to indicate whether to switch waveforms of physical channels of all cells in different cell groups.

In this embodiment of this application, if scheduled cells are from the plurality of groups (for example, a part that is of the cells and that is in inter-band carrier aggregation is in band 1, and other cells are in band 2), a waveform may be indicated by using a bitmap for a cell of each group.

Case 3: In a case that the plurality of cells include a plurality of cell groups, intra-band carrier aggregation is used between a plurality of cells in each cell group, and cells between the cell groups are in an inter-band relationship, the terminal switches, based on the first indication information, waveforms of the physical channels of the plurality of cells according to a preset rule includes the following step.

The terminal separately switches, based on the first indication information, waveforms of physical channels of all cells in each cell group to a same waveform, where the first indication information is used to indicate whether to switch waveforms of physical channels of all cells in different cell groups to a same waveform, and first indication information corresponding to each cell group is independently configured.

In this embodiment of this application, cells between the cell groups are in an inter-band relationship, cells in the cell groups are in an intra-band relationship, and the first indication information corresponding to the cell group is configured independently. Switching may be performed on each cell group in the manner described in the foregoing Case 1.

For example, there are four cell groups (G0, G1, G2, and G3). Different cell groups use different bands, and each group has four cells that use a same band. Four bits may be introduced, namely b0, b1, b2, and b3, which respectively indicate whether waveform switching is performed on a PUSCH of a cell in the G0/G1/G2/G3. If waveform switching is performed on each group (a corresponding bit is set to 1), it can be considered that a waveform of a PUSCH of a non-reference cell in the group is switched to a waveform of a PUSCH of a reference cell in the group.

Case 4: In a case that the plurality of cells belong to a same TAG, the terminal switches, based on the first indication information, waveforms of the physical channels of the plurality of cells according to a preset rule includes one or more of the following.

(1) The terminal switches, based on the first indication information, waveforms of physical channels of all cells in the cell group to a same waveform, where the first indication information is used to indicate whether to switch waveforms of physical channels of different cells in the cell group.

In this embodiment of this application, DWS configuration occurs in each cell of the cell group, and a network ensures that there is no different waveform between a plurality of PUSCHs scheduled by the DCI in the cell group.

(2) The terminal switches, based on the first indication information, a waveform of a physical channel of a first cell in the cell group to the same as a waveform of a physical channel of a second cell in the cell group, where the first cell is a cell in the cell group except the second cell, and the first indication information is used to indicate whether to switch the waveform of the physical channel of the first cell.

In this embodiment of this application, DWS is determined by a waveform of a PUSCH of a specific cell (that is, the second cell) in the cell group. In a case that a waveform configured for the first cell in the cell group is different from the waveform of the PUSCH of the specific cell, DWS is performed on the PUSCH of the first cell; otherwise, DWS is not performed. This is to ensure that PUSCHs of all the cells in the group have a same waveform.

In some embodiments, the second cell is configured by a network side, for example, configured by RRC signaling, MAC signaling, and DCI signaling, or the second cell is stipulated in a protocol, for example, a cell with a smallest PCI in a multi-cell PUSCH.

Case 5: In a case that the plurality of cells include one or more cell groups, and a plurality of cells in each cell group belong to different TAGs, the terminal switches, based on the first indication information, waveforms of the physical channels of the plurality of cells according to a preset rule includes one or more of the following.

(1) In a case that the plurality of cells include one cell group, independently determining, by the terminal based on the first indication information, whether to switch a waveform of a physical channel of each cell in the cell group, where the first indication information is used to indicate whether to switch waveforms of physical channels of different cells in the cell group.

In this embodiment of this application, DWS occurs in each cell of the cell group, so that there is independent waveform switching between a plurality of PUSCHs scheduled by the DCI in the cell group. During specific implementation, one bit is used in the first indication information to indicate switching for each cell, or an indication bit is jointly encoded with TDRA, FDRA, or the like.

(2) In a case that the plurality of cells include a plurality of cell groups, the terminal separately switches, based on the first indication information, waveforms of physical channels of all cells in each cell group, where the first indication information is used to separately indicate whether to switch waveforms of physical channels of all cells in different cell groups.

In this embodiment of this application, if scheduled cells are from the plurality of groups (for example, a part that is of the cells and that is in inter-band carrier aggregation is in band 1, and other cells are in band 2), a waveform may be indicated by using a bitmap for a cell of each group.

Case 6: In a case that the plurality of cells include a plurality of cell groups, a plurality of cells in each cell group belong to a same TAG, and cells between the cell groups belong to diffident TAGs, the terminal switches, based on the first indication information, waveforms of the physical channels of the plurality of cells according to a preset rule includes the following step.

The terminal separately switches, based on the first indication information, waveforms of physical channels of all cells in each cell group to a same waveform respectively, where the first indication information is used to separately indicate whether to switch waveforms of physical channels of all cells in different cell groups to a same waveform, and first indication information corresponding to each cell group is independently configured.

In this embodiment of this application, cells between the cell groups belong to different TAGs, cells in the cell groups belong to a same TAG, and the first indication information corresponding to the cell group is configured independently. Switching may be performed on each cell group in the manner described in the foregoing Case 1.

For example, there are four cell groups (G0, G1, G2, and G3). Different cell groups belong to different TAGs, and each group has four cells that belong to a same TAG. Four bits may be introduced, namely b0, b1, b2, and b3, which respectively indicate whether waveform switching is performed on a PUSCH of a cell in the G0/G1/G2/G3. If waveform switching is performed on each group (a corresponding bit is set to 1), it can be considered that a waveform of a PUSCH of a non-reference cell in the group is switched to a waveform of a PUSCH of a reference cell in the group.

In a possible implementation, the first indication information meets any one of the following:

(1) the first indication information is jointly encoded with an FDRA field in the first DCI;

(2) the first indication information is jointly encoded with a TDRA field in the first DCI; or

(3) the first indication information is jointly encoded with a BWP index field in the first DCI.

Signaling overheads required to support dynamic waveform switching is reduced by jointly encoding information about dynamic waveform switching of a multi-cell PUSCH and other information.

In a possible implementation, the first DCI further carries second indication information, and the second indication information is used to instruct the terminal to switch the waveforms of the physical channels of the plurality of cells to a target waveform.

In this embodiment of this application, if types of waveforms include not only CP-OFDM and DFT-s-OFDM, but also another type, a bit used to indicate a specific target waveform may be added to the DCI. In some embodiments, the bit may be jointly encoded with other information in the DCI, so as to reduce the signaling overheads required to support dynamic waveform switching.

In a possible implementation, the first DCI meets one or more of the following:

(1) a format of the first DCI is format 0_1 or format 0_2; and

(2) a size of the first DCI is not less than that of DCI format 0_1.

The following describes technical solutions of this application with reference to specific examples.

### Example 1: Multi-Cell PUSCH DWS in Intra-Band Carrier Aggregation

A multi-cell PUSCH in intra-band carrier aggregation has a same waveform after DWS. This may be implemented using one or more of the following methods.

Manner 1: DWS configuration occurs in each cell of the cell group, and a network ensures that there is no different waveform between a plurality of PUSCHs scheduled by the DCI in the cell group.

(1) For example, for each cell in intra-band carrier aggregation in the cell group, one bit is used to indicate whether DWS is performed. It is assumed that one piece of DCI can schedule PUSCHs of up to N cells, and N bits may be used to indicate whether dynamic waveform switching is performed on a PUSCH of each cell. The N bits here may correspond to a Least Significant Bit (LSB) to a Most Significant Bit (MSB) in an order of increasing cell ID. For example, a four-bit field b₃b2b₁b₀ is used to indicate whether dynamic waveform switching is performed on PUSCHs of four cells (respectively PCI 3, PCI 2, PCI 1, PCI 0, meeting PCI 3>PCI 2>PCI 1>PCI 0). In a case that b₃b₂b₁b₀=0101_{b}, dynamic waveform switching is performed on the PUSCH on the PCI 2 and the PUSCH on the PCI 0, and waveform switching is not performed on the other two cells, as shown in Table 3.

TABLE 3

| b₃ (MSB) | b₂ | b₁ | b₀ (LSB) |
|---|---|---|---|
| PCI 3 | PCI 2 | PCI 1 | PCI 0 |

Manner 2: DWS is determined by a waveform of a PUSCH of a specific cell in the intra-band cell group. In a case that a waveform configured for the first cell in the cell group is different from the waveform of the PUSCH of the specific cell, DWS is performed on the PUSCH of the first cell; otherwise, DWS is not performed. This is to ensure that PUSCHs of all the cells in the group have a same waveform.

The specific cell here can be specified by a network configuration, such as RRC signaling, MAC signaling, and DCI signaling.

For example, a PCI of the specific cell is configured by using RRC signaling on a BWP of a cell in which scheduling DCI is located, where a PUSCH waveform corresponding to the PCI is a reference waveform. If waveforms of all other cells corresponding to the serving cell are different from the PUSCH waveform of the serving cell, DWS needs to be performed.

In some embodiments, for example, a PCIwaveformReference field is used to indicate a reference serving cell.

In some embodiments, in a case that a serving cell is configured, a parameter is configured to indicate whether the serving cell is a waveform reference serving cell (the specific cell). To be specific, a waveform of a PUSCH of another cell needs to follow a waveform of the reference serving cell.

For example, a WaveformReference field is used to indicate whether a current cell is a waveform reference serving cell.

In some embodiments, the reference serving cell is stipulated in a protocol.

For example, a cell with a smallest PCI in the multi-cell PUSCH.

DWS is performed on the entire cell group.

For example, for each cell group, one-bit signaling is used to indicate whether the group of cells would simultaneously switch to the DFT-s-OFDM waveform or to the CP-OFDM waveform. As shown in the following table, three bits b₀b₁b₂ are defined to indicate whether dynamic waveform switching is performed on a PUSCH in a cell group A, a PUSCH in cell group B, a PUSCH in cell group C, respectively. Here, in a case that cells in different cell groups are in an inter-band relationship and cells in each cell group are in intra-cell CA, details are shown in Table 4.

TABLE 4

| b₂ | b₁ | b₀ (LSB) |
|---|---|---|
| PCI group C | PCI group B | PCI group A |

Manner 3: In a case that the multi-cell PUSCH has a plurality of layers for transmission, all PUSCHs in the DFT-s-OFDM waveform is switched to the CP-OFDM waveform. The second cell in Manner 2 is a cell that transmits a PUSCH on the plurality of layers.

### Example 2: Multi-Cell PUSCH DWS in Inter-Band Carrier Aggregation

DWS is individually performed on a multi-cell in inter-band carrier aggregation. This may be implemented using one or more of the following manners.

Manner 1: A multi-cell in each band only needs one bit to indicate switching, or is jointly encoded with TDRA/FDRA or the like.

Manner 2: If scheduled cells are from a plurality of groups (for example, a part that is of the cells and that is in inter-band carrier aggregation is in band 1, and other cells are in band 2), a waveform may be indicated by using a bitmap for a cell of each group. For example, there are three bits b₀, b₁, b₂, each bit indicates whether dynamic waveform switching is performed on a PUSCH in a PUSCH group 0/1/2. Here, the PUSCH group 0/1/2 is respectively in three different bands, namely, band 0, 1, 2, as shown in Table 5.

TABLE 5

| b₂ | b₁ | b₀ (LSB) |
|---|---|---|
| PUSCH group 2 | PUSCH group 1 | PUSCH group 0 |
| in band 2 | in band 1 | in band 0 |

### Example 3: DWS of a PUSCH of a Multi-Cell that Belongs to a Same TAG

A plurality of PUSCHs scheduled by DCI are PUSCHs on a multi-cell, and the multi-cell includes one or more groups of multi-cells, where each group of multi-cells belongs to a same timing advance group (TAG), and the group of multi-cell PUSCHs scheduled by the single piece of DCI uses a same waveform. This may be implemented using one or more of the following methods.

Manner 1: DWS configuration occurs in each cell of the cell group, and a network ensures that there is no different waveform between a plurality of PUSCHs scheduled by the first DCI in the cell group.

For example, one bit is used to indicate whether DWS is performed on each cell. It is assumed that one piece of DCI can schedule PUSCHs of up to N cells belong to a same TAG, and N bits may be used to indicate whether dynamic waveform switching is performed on a PUSCH of each cell. The N bits here may correspond to an LSB to an MSB in an order of increasing cell ID. For example, N=4 and a four-bit field b₃b₂b₁b₀ is used to indicate whether dynamic waveform switching is performed on PUSCHs of four cells (respectively PCI 3, PCI 2, PCI 1, PCI 0, meeting PCI 3>PCI 2>PCI 1>PCI 0). In a case that b₃b₂b₁b₀=0101_{b}, dynamic waveform switching is performed on the PUSCH on the PCI 2 and the PUSCH on the PCI 0, and waveform switching is not performed on the other two cells, as shown in Table 6.

TABLE 6

| b₃ (MSB) | b₂ | b₁ | b₀ (LSB) |
|---|---|---|---|
| PCI 3 | PCI 2 | PCI 1 | PCI 0 |

Manner 2: DWS is determined by a waveform of a specific cell in the cell group that belongs to the same TAG. In a case that a waveform configured for the first cell in the cell group is different from the waveform of the of the specific cell, DWS is performed on the PUSCH of the first cell; otherwise, DWS is not performed. This is to ensure that PUSCHs of all the cells in the group have a same waveform.

The specific cell here is specified by a network configuration, such as RRC signaling, MAC signaling, and DCI signaling.

For example, a PCI of the specific cell is configured by using RRC signaling on a BWP of a cell in which scheduling DCI is located, where a PUSCH waveform corresponding to the PCI is a reference waveform. If waveforms of all other cells corresponding to the serving cell are different from the PUSCH waveform of the serving cell, DWS needs to be performed.

For example, a PCIwaveformReference field is used to indicate a reference serving cell.

In some embodiments, in a case that a serving cell is configured, a parameter is configured to indicate whether the serving cell is a waveform reference serving cell (the specific cell). To be specific, a waveform of a PUSCH of another cell needs to follow a waveform of the reference serving cell.

For example, a WaveformReference field is used to indicate whether a current cell is a waveform reference serving cell.

In some embodiments, the reference serving cell is stipulated in a protocol.

For example, a cell with a smallest PCI in the multi-cell PUSCH.

DWS is performed on the entire cell group.

For example, for each cell group, one-bit signaling is used to indicate whether to simultaneously switch to the DFT-s-OFDM waveform or to the CP-OFDM waveform. As shown in the following figure, three bits b₀, b₁, b₂ are defined to indicate whether dynamic waveform switching is performed on a PUSCH in a cell group A, a PUSCH in a cell group B, a PUSCH in a cell group C respectively. The cell group A/B/C belongs to a different TAG.

Manner 3: In a case that the multi-cell PUSCH has a plurality of layers for transmission, all PUSCHs in the DFT-s-OFDM waveform is switched to the CP-OFDM waveform. The second cell in Manner 2 is a cell that transmits a PUSCH on the plurality of layers.

### Example 4: DWS of a Multi-Cell PUSCH Jointly Configured with Other Information

Manner 1: DWS of the multi-cell PUSCH may be jointly configured with one or more pieces of the following information:

Frequency domain resource assignment (FDRA) of the multi-cell PUSCH:

For example, N_{UL-dws} MSB bits of an FDRA field is used to indicate DWS of a group of multi-cell PUSCHs.

Manner 2: Time domain resource assignment relationship of the multi-cell PUSCH

For example, N_{UL-dws} MSB bits of a TDRA field is used to indicate DWS of a group of multi-cell PUSCHs.

Manner 3: A BWP in which the multi-cell PUSCH is located

For example, N_{UL-dws} MSB bits of a BWP index field is used to indicate DWS of a group of multi-cell PUSCHs.

The BWP index here may indicate a plurality of BWPs, which correspond to a target BWP of each cell PUSCH, so as to implement dynamic BWP switching and dynamic waveform switching of the multi-cell PUSCH.

The method for waveform switching provided in the embodiments of this application may be executed by an apparatus for waveform switching. In the embodiments of this application, an example in which the apparatus for waveform switching performs the method for waveform switching is used to describe the apparatus for waveform switching provided in the embodiments of this application.

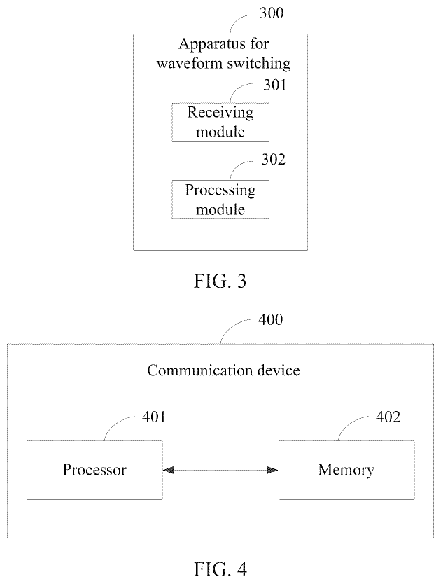

Refer to FIG. 3. An embodiment of this application provides an apparatus 300 for waveform switching, including:
a receiving module 301, configured to receive first DCI from a network device, where the first DCI is used to schedule physical channels of a plurality of cells; and
a processing module 302, configured to: in a case that the first DCI carries first indication information, switch based on the first indication information, waveforms of the physical channels of the plurality of cells according to a preset rule, where the preset rule is associated with an attribute of the plurality of cells; or
the terminal uses pre-configured waveforms of the physical channels of the plurality of cells.

In some embodiments, in a case that the first DCI is used to schedule physical channels of a plurality of cells, the terminal does not support dynamic waveform switching.

In some embodiments, the attribute of the plurality of cells includes one or more of the following:
a relationship among the plurality of cells on a frequency domain resource;
a frequency domain resource assignment manner of the physical channels of the plurality of cells;
a time domain resource assignment relationship of the physical channels of the plurality of cells;
a BWP in which the physical channels of the plurality of cells are located; and
whether the plurality of cells belong to a same TAG.

In some embodiments, in a case that the plurality of cells include one or more cell groups, and intra-band carrier aggregation is used between a plurality of cells in each cell group, the processing module is configured to perform one or more of the following:
switch based on the first indication information, waveforms of physical channels of all cells in the cell group to a same waveform, where the first indication information is used to indicate whether to switch waveforms of physical channels of different cells in the cell group; and
switch based on the first indication information, a waveform of a physical channel of a first cell in the cell group to the same as a waveform of a physical channel of a second cell in the cell group, where the first cell is a cell in the cell group except the second cell, and the first indication information is used to indicate whether to switch the waveform of the physical channel of the first cell.

In some embodiments, in a case that the plurality of cells include one or more cell groups, and inter-band carrier aggregation is used between a plurality of cells in each cell group, the processing module is configured to perform one or more of the following:
in a case that the plurality of cells include one cell group, independently determine based on the first indication information, whether to switch a waveform of a physical channel of each cell in the cell group, where the first indication information is used to indicate whether to switch waveforms of physical channels of different cells in the cell group; and
in a case that the plurality of cells include a plurality of cell groups, separately switch based on the first indication information, waveforms of physical channels of all cells in each cell group, where the first indication information is used to indicate whether to switch waveforms of physical channels of all cells in different cell groups.

In some embodiments, in a case that the plurality of cells include a plurality of cell groups, intra-band carrier aggregation is used between a plurality of cells in each cell group, and cells between the cell groups are in an inter-band relationship, the processing module is configured to perform one or more of the following:
separately switching based on the first indication information, waveforms of physical channels of all cells in each cell group to a same waveform, where the first indication information is used to indicate whether to switch waveforms of physical channels of all cells in different cell groups to a same waveform, and first indication information corresponding to each cell group is independently configured.

In some embodiments, in a case that the plurality of cells belong to a same TAG, the processing module is configured to perform one or more of the following:
switch based on the first indication information, waveforms of physical channels of all cells in the cell group to a same waveform, where the first indication information is used to indicate whether to switch waveforms of physical channels of different cells in the cell group; and
switch based on the first indication information, a waveform of a physical channel of a first cell in the cell group to the same as a waveform of a physical channel of a second cell in the cell group, where the first cell is a cell in the cell group except the second cell, and the first indication information is used to indicate whether to switch the waveform of the physical channel of the first cell.

In some embodiments, in a case that the plurality of cells include one or more cell groups, and a plurality of cells in each cell group belong to different TAGs, the processing module is configured to perform one or more of the following:
in a case that the plurality of cells include one cell group, independently determine based on the first indication information, whether to switch a waveform of a physical channel of each cell in the cell group, where the first indication information is used to indicate whether to switch waveforms of physical channels of different cells in the cell group; and
in a case that the plurality of cells include a plurality of cell groups, separately switch based on the first indication information, waveforms of physical channels of all cells in each cell group, where the first indication information is used to separately indicate whether to switch waveforms of physical channels of all cells in different cell groups.

In some embodiments, in a case that the plurality of cells include a plurality of cell groups, a plurality of cells in each cell group belong to a same TAG, and cells between the cell groups belong to diffident TAGs, the processing module is configured to perform one or more of the following:
separately switch based on the first indication information, waveforms of physical channels of all cells in each cell group to a same waveform respectively, where the first indication information is used to separately indicate whether to switch waveforms of physical channels of all cells in different cell groups to a same waveform, and first indication information corresponding to each cell group is independently configured.

In some embodiments, the second cell is configured by a network side, or the second cell is stipulated in a protocol.

In some embodiments, the first indication information meets any one of the following:
the first indication information is jointly encoded with an FDRA field in the first DCI;
the first indication information is jointly encoded with a TDRA field in the first DCI; or
the first indication information is jointly encoded with a BWP index field in the first DCI.

In some embodiments, the first DCI further carries second indication information, and the second indication information is used to instruct the terminal to switch the waveforms of the physical channels of the plurality of cells to a target waveform.

In some embodiments, the first DCI meets one or more of the following:
a format of the first DCI is format 0_1 or format 0_2; and
a size of the first DCI is not less than that of DCI format 0_1.

The apparatus for waveform switching in the embodiments of this application may be an electronic device having an operating system, or may be a component, such as an integrated circuit, or a chip in an electronic device. The electronic device may be a terminal, or another device other than the terminal. For example, the terminal may include but is not limited to the foregoing listed types of the terminal 11. The another device may be a server, a network attached storage (NAS), or the like. This is not specifically limited in the embodiments of this application.

The apparatus for waveform switching provided in the embodiments of this application can implement the processes implemented in the method embodiment of FIG. 2 and achieve a same technical effect. To avoid repetition, details are not described herein again.

As shown in FIG. 4, an embodiment of this application further provides a communication device 400, including a processor 401 and a memory 402, and the memory 402 stores a program or an instruction that can be run on the processor 401. For example, when the communication device 400 is a terminal, the program or the instruction is executed by the processor 401 to implement the processes of the foregoing embodiments of the method for waveform switching, and a same technical effect can be achieved. When the communication device 400 is a network side device, the program or the instruction is executed by the processor 401 to implement the steps of the foregoing embodiments of the method for waveform switching, and a same technical effect can be achieved. To avoid repetition, details are not described herein again.

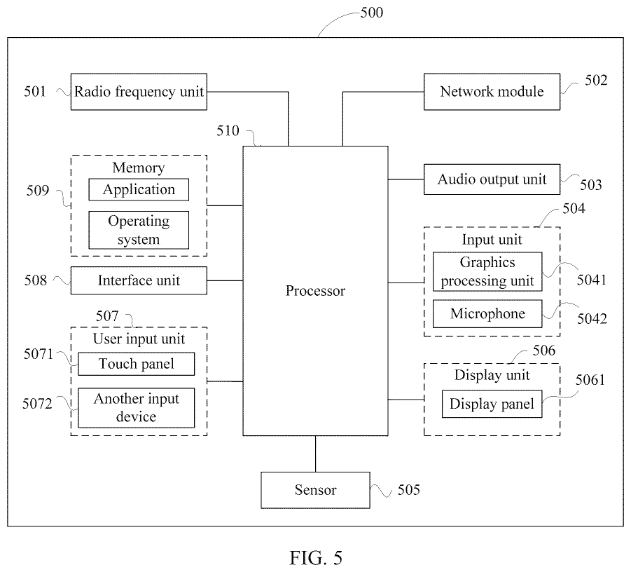

An embodiment of this application further provides a terminal, including a processor and a communication interface. The communication interface is configured to receive, by the terminal, a first DCI from a network device, where the first DCI is used to schedule physical channels of a plurality of cells. The processor is configured to: in a case that the first DCI carries first indication information, switch based on the first indication information, waveforms of the physical channels of the plurality of cells according to a preset rule, where the preset rule is associated with an attribute of the plurality of cells; or the terminal uses pre-configured waveforms of the physical channels of the plurality of cells. The terminal embodiment is corresponding to the terminal side method embodiment, each implementation process and implementation of the method embodiment can be applied to the terminal embodiment, and a same technical effect can be achieved. FIG. 5 is a schematic diagram of a hardware structure of a terminal according to an embodiment of this application.

The terminal 500 includes but is not limited to at least a part of components of a radio frequency unit 501, a network module 502, an audio output unit 503, an input unit 504, a sensor 505, a display unit 506, a user input unit 507, an interface unit 508, a memory 509, and a processor 510, and the like.

A person skilled in the art can understand that the terminal 500 may further include a power supply (such as a battery) that supplies power to each component. The power supply may be logically connected to the processor 510 by using a power supply management system, to implement functions such as charging and discharging management, and power consumption management by using the power supply management system. The terminal structure shown in FIG. 5 constitutes no limitation on the terminal, and the terminal may include more or fewer components than those shown in the figure, or combine some components, or have different component arrangements. Details are not described herein.

It should be understood that in this embodiment of this application, the input unit 504 may include a Graphics Processing Unit (GPU) 5041 and a microphone 5042. The graphics processing unit 5041 processes image data of a static picture or a video obtained by an image capture apparatus (for example, a camera) in a video capture mode or an image capture mode. The display unit 506 may include a display panel 5061, and the display panel 5061 may be configured in a form of a liquid crystal display, an organic light-emitting diode, or the like. The user input unit 507 includes at least one of a touch panel 5071 or another input device 5072. The touch panel 5071 is also referred to as a touchscreen. The touch panel 5071 may include two parts: a touch detection apparatus and a touch controller. The another input device 5072 may include but is not limited to a physical keyboard, a functional button (such as a volume control button or a power on/off button), a trackball, a mouse, and a joystick. Details are not described herein.

In this embodiment of this application, the radio frequency unit 501 receives downlink data from a network side device and then sends the downlink data to the processor 510 for processing. In addition, the radio frequency unit 501 may send uplink data to the network side device. Usually, the radio frequency unit 501 includes but is not limited to an antenna, an amplifier, a transceiver, a coupler, a low noise amplifier, a duplexer, and the like.

The memory 509 may be configured to store a software program or an instruction and various data. The memory 509 may mainly include a first storage area for storing a program or an instruction and a second storage area for storing data. The first storage area may store an operating system, and an application or an instruction required by at least one function (for example, a sound playing function or an image playing function). In addition, the memory 509 may be a volatile memory or a non-volatile memory, or the memory 509 may include a volatile memory and a non-volatile memory. The non-volatile memory may be a Read-Only Memory (ROM), a Programmable ROM (PROM), an Erasable PROM (EPROM), an Electrically EPROM (EEPROM), or a flash memory. The volatile memory may be a Random Access Memory (RAM), a Static RAM (SRAM), a Dynamic RAM (DRAM), a Synchronous DRAM (SDRAM), a Double Data Rate SDRAM (DDRSDRAM), an Enhanced SDRAM (ESDRAM), a Synchlink DRAM (SLDRAM), and a Direct Rambus RAM (DRRAM). The memory 509 in this embodiment of this application includes but is not limited to these memories and any memory of another proper type.

The processor 510 may include one or more processing units. In some embodiments, an application processor and a modem processor may be integrated into the processor 510. The application processor mainly processes an operating system, a user interface, an application, and the like. The modem processor mainly processes a wireless communication signal, for example, a baseband processor. It may be understood that, the modem processor may not be integrated into the processor 510.

The radio frequency unit 501 is configured to receive first DCI from a network device, where the first DCI is used to schedule physical channels of a plurality of cells.

The processor 510 is configured to: in a case that the first DCI carries first indication information, switch based on the first indication information, waveforms of the physical channels of the plurality of cells according to a preset rule, where the preset rule is associated with an attribute of the plurality of cells; or
the terminal uses pre-configured waveforms of the physical channels of the plurality of cells.

In some embodiments, in a case that the first DCI is used to schedule physical channels of a plurality of cells, the terminal does not support dynamic waveform switching.

In some embodiments, the attribute of the plurality of cells includes one or more of the following:
a relationship among the plurality of cells on a frequency domain resource;
a frequency domain resource assignment manner of the physical channels of the plurality of cells;
a time domain resource assignment relationship of the physical channels of the plurality of cells;
a BWP in which the physical channels of the plurality of cells are located; and
whether the plurality of cells belong to a same TAG.

In some embodiments, in a case that the plurality of cells include one or more cell groups, and intra-band carrier aggregation is used between a plurality of cells in each cell group, the processor 510 is configured to perform one or more of the following:
switch based on the first indication information, waveforms of physical channels of all cells in the cell group to a same waveform, where the first indication information is used to indicate whether to switch waveforms of physical channels of different cells in the cell group; and
switch based on the first indication information, a waveform of a physical channel of a first cell in the cell group to the same as a waveform of a physical channel of a second cell in the cell group, where the first cell is a cell in the cell group except the second cell, and the first indication information is used to indicate whether to switch the waveform of the physical channel of the first cell.

In some embodiments, in a case that the plurality of cells include one or more cell groups, and inter-band carrier aggregation is used between a plurality of cells in each cell group, the processor 510 is configured to perform one or more of the following:
in a case that the plurality of cells include one cell group, independently determine based on the first indication information, whether to switch a waveform of a physical channel of each cell in the cell group, where the first indication information is used to indicate whether to switch waveforms of physical channels of different cells in the cell group; and
in a case that the plurality of cells include a plurality of cell groups, separately switch based on the first indication information, waveforms of physical channels of all cells in each cell group, where the first indication information is used to indicate whether to switch waveforms of physical channels of all cells in different cell groups.

In some embodiments, in a case that the plurality of cells include a plurality of cell groups, intra-band carrier aggregation is used between a plurality of cells in each cell group, and cells between the cell groups are in an inter-band relationship, the processor 510 is configured to perform one or more of the following:
separately switch based on the first indication information, waveforms of physical channels of all cells in each cell group to a same waveform, where the first indication information is used to indicate whether to switch waveforms of physical channels of all cells in different cell groups to a same waveform, and first indication information corresponding to each cell group is independently configured.

In some embodiments, in a case that the plurality of cells belong to a same TAG, the processor 510 is configured to perform one or more of the following:
switch based on the first indication information, waveforms of physical channels of all cells in the cell group to a same waveform, where the first indication information is used to indicate whether to switch waveforms of physical channels of different cells in the cell group; and
switch based on the first indication information, a waveform of a physical channel of a first cell in the cell group to the same as a waveform of a physical channel of a second cell in the cell group, where the first cell is a cell in the cell group except the second cell, and the first indication information is used to indicate whether to switch the waveform of the physical channel of the first cell.

In some embodiments, in a case that the plurality of cells include one or more cell groups, and a plurality of cells in each cell group belong to different TAGs, the processor 510 is configured to perform one or more of the following:
in a case that the plurality of cells include one cell group, independently determine based on the first indication information, whether to switch a waveform of a physical channel of each cell in the cell group, where the first indication information is used to indicate whether to switch waveforms of physical channels of different cells in the cell group; and
in a case that the plurality of cells include a plurality of cell groups, separately switch based on the first indication information, waveforms of physical channels of all cells in each cell group, where the first indication information is used to separately indicate whether to switch waveforms of physical channels of all cells in different cell groups.

In some embodiments, in a case that the plurality of cells include a plurality of cell groups, a plurality of cells in each cell group belong to a same TAG, and cells between the cell groups belong to diffident TAGs, the processor 510 is configured to perform one or more of the following:
separately switch based on the first indication information, waveforms of physical channels of all cells in each cell group to a same waveform respectively, where the first indication information is used to separately indicate whether to switch waveforms of physical channels of all cells in different cell groups to a same waveform, and first indication information corresponding to each cell group is independently configured.

In some embodiments, the second cell is configured by a network side, or the second cell is stipulated in a protocol.

In some embodiments, the first indication information meets any one of the following:
the first indication information is jointly encoded with an FDRA field in the first DCI;
the first indication information is jointly encoded with a TDRA field in the first DCI; or
the first indication information is jointly encoded with a BWP index field in the first DCI.

In some embodiments, the first DCI further carries second indication information, and the second indication information is used to instruct the terminal to switch the waveforms of the physical channels of the plurality of cells to a target waveform.

In some embodiments, the first DCI meets one or more of the following:
a format of the first DCI is format 01 or format 0_2; and
a size of the first DCI is not less than that of DCI format 0_1.

An embodiment of this application further provides a readable storage medium. The readable storage medium stores a program or an instruction. The program or the instruction is executed by a processor to implement the processes of the foregoing embodiment of the method for waveform switching, and a same technical effect can be achieved. To avoid repetition, details are not described herein again.

The processor is a processor in the terminal in the foregoing embodiments. The readable storage medium includes a computer-readable storage medium, such as a computer read-only memory ROM, a random access memory RAM, a magnetic disk, or an optical disc.

An embodiment of this application further provides a chip. The chip includes a processor and a communication interface, where the communication interface is coupled to the processor, and the processor is configured to run a program or an instruction to implement the processes of the foregoing embodiment of the method for waveform switching, and a same technical effect can be achieved. To avoid repetition, details are not described herein again.

It should be understood that the chip mentioned in this embodiment of this application may also be referred to as a system-level chip, a system chip, a chip system, or a system on chip.

An embodiment of this application further provides a computer program/program product. The computer program/program product is stored in a storage medium, and the program/program product is executed by at least one processor to implement the processes of the foregoing embodiment of the method for waveform switching, and a same technical effect can be achieved. To avoid repetition, details are not described herein again.

It should be noted that, in this specification, the term “include”, “comprise”, or any other variant thereof is intended to cover a non-exclusive inclusion, so that a process, a method, an article, or an apparatus that includes a list of elements not only includes those elements but also includes other elements which are not expressly listed, or further includes elements inherent to this process, method, article, or apparatus. In absence of more constraints, an element preceded by “includes a . . . ” does not preclude the existence of other identical elements in the process, method, article, or apparatus that includes the element. In addition, it should be noted that the scope of the methods and apparatuses in the embodiments of this application is not limited to performing functions in the order shown or discussed, but may also include performing the functions in a basically simultaneous manner or in opposite order based on the functions involved. For example, the described methods may be performed in a different order from the described order, and various steps may be added, omitted, or combined. In addition, features described with reference to some examples may be combined in other examples.

Based on the descriptions of the foregoing implementations, a person skilled in the art may clearly understand that the method in the foregoing embodiment may be implemented by software in addition to a necessary universal hardware platform or by hardware only. In most circumstances, the former is a preferred implementation. Based on such an understanding, the technical solutions of this application essentially or the part contributing to the prior art may be implemented in a form of a computer software product. The computer software product is stored in a storage medium (for example, a ROM/RAM, a floppy disk, or an optical disc), and includes several instructions for instructing a terminal (which may be a mobile phone, a computer, a server, an air conditioner, a network device, or the like) to perform the methods described in the embodiments of this application.

The embodiments of this application are described above with reference to the accompanying drawings, but this application is not limited to the foregoing specific implementations, and the foregoing specific implementations are only illustrative and not restrictive. Under the enlightenment of this application, a person of ordinary skill in the art can make many forms without departing from the purpose of this application and the protection scope of the claims, all of which fall within the protection of this application.

1. A method for waveform switching, comprising:
receiving, by a terminal, first downlink control information (DCI) from a network device, wherein the first DCI is used to schedule physical channels of a plurality of cells; and
using, by the terminal, pre-configured waveforms of the physical channels of the plurality of cells,
wherein when the first DCI is used to schedule the physical channels of the plurality of cells, the terminal does not support dynamic waveform switching.

2. The method according to claim 1, further comprising:
when the first DCI carries first indication information, switching, by the terminal based on the first indication information, waveforms of the physical channels of the plurality of cells according to a preset rule, wherein the preset rule is associated with an attribute of the plurality of cells,
wherein the attribute of the plurality of cells comprises one or more of the following:
a relationship among the plurality of cells on a frequency domain resource;
a frequency domain resource assignment manner of the physical channels of the plurality of cells;
a time domain resource assignment relationship of the physical channels of the plurality of cells;
a bandwidth part (BWP) in which the physical channels of the plurality of cells are located; or
whether the plurality of cells belong to a same timing advance group (TAG).

3. The method according to claim 2, wherein
when the plurality of cells comprise one or more cell groups, and intra-band carrier aggregation is used between a plurality of cells in each cell group, the switching, by the terminal based on the first indication information, waveforms of the physical channels of the plurality of cells according to a preset rule comprises one or more of the following:
switching, by the terminal based on the first indication information, waveforms of physical channels of all cells in the cell group to a same waveform, wherein the first indication information is used to indicate whether to switch waveforms of physical channels of different cells in the cell group; or
switching, by the terminal based on the first indication information, a waveform of a physical channel of a first cell in the cell group to the same as a waveform of a physical channel of a second cell in the cell group, wherein the first cell is a cell in the cell group except the second cell, and the first indication information is used to indicate whether to switch the waveform of the physical channel of the first cell.

4. The method according to claim 2, wherein when the plurality of cells comprise one or more cell groups, and inter-band carrier aggregation is used between a plurality of cells in each cell group, the switching, by the terminal based on the first indication information, waveforms of the physical channels of the plurality of cells according to a preset rule comprises one or more of the following:
when the plurality of cells comprise one cell group, independently determining, by the terminal based on the first indication information, whether to switch a waveform of a physical channel of each cell in the cell group, wherein the first indication information is used to indicate whether to switch waveforms of physical channels of different cells in the cell group; or
when the plurality of cells comprise a plurality of cell groups, separately switching, by the terminal based on the first indication information, waveforms of physical channels of all cells in each cell group, wherein the first indication information is used to indicate whether to switch waveforms of physical channels of all cells in different cell groups.

5. The method according to claim 2, wherein when the plurality of cells comprise a plurality of cell groups, intra-band carrier aggregation is used between a plurality of cells in each cell group, and cells between the cell groups are in an inter-band relationship, the switching, by the terminal based on the first indication information, waveforms of the physical channels of the plurality of cells according to a preset rule comprises:
separately switching, by the terminal based on the first indication information, waveforms of physical channels of all cells in each cell group to a same waveform, wherein the first indication information is used to indicate whether to switch waveforms of physical channels of all cells in different cell groups to a same waveform, and first indication information corresponding to each cell group is independently configured.

6. The method according to claim 2, wherein when the plurality of cells belong to a same TAG, the switching, by the terminal based on the first indication information, waveforms of the physical channels of the plurality of cells according to a preset rule comprises one or more of the following:
switching, by the terminal based on the first indication information, waveforms of physical channels of all cells in the cell group to a same waveform, wherein the first indication information is used to indicate whether to switch waveforms of physical channels of different cells in the cell group; or
switching, by the terminal based on the first indication information, a waveform of a physical channel of a first cell in the cell group to the same as a waveform of a physical channel of a second cell in the cell group, wherein the first cell is a cell in the cell group except the second cell, and the first indication information is used to indicate whether to switch the waveform of the physical channel of the first cell.

7. The method according to claim 2, wherein when the plurality of cells comprise one or more cell groups, and a plurality of cells in each cell group belong to a same TAG, the switching, by the terminal based on the first indication information, waveforms of the physical channels of the plurality of cells according to a preset rule comprises one or more of the following:
when the plurality of cells comprise one cell group, independently determining, by the terminal based on the first indication information, whether to switch a waveform of a physical channel of each cell in the cell group, wherein the first indication information is used to indicate whether to switch waveforms of physical channels of different cells in the cell group; or
when the plurality of cells comprise a plurality of cell groups, separately switching, by the terminal based on the first indication information, waveforms of physical channels of all cells in each cell group, wherein the first indication information is used to separately indicate whether to switch waveforms of physical channels of all cells in different cell groups.

8. The method according to claim 2, wherein when the plurality of cells comprise a plurality of cell groups, a plurality of cells in each cell group belong to a same TAG, and cells between the cell groups belong to diffident TAGs, the switching, by the terminal based on the first indication information, waveforms of the physical channels of the plurality of cells according to a preset rule comprises:
separately switching, by the terminal based on the first indication information, waveforms of physical channels of all cells in each cell group to a same waveform respectively, wherein the first indication information is used to separately indicate whether to switch waveforms of physical channels of all cells in different cell groups to a same waveform, and first indication information corresponding to each cell group is independently configured.

9. The method according to claim 3, wherein the second cell is configured by a network side, or the second cell is stipulated in a protocol.

10. The method according to claim 2, wherein the first indication information meets any one of the following:
the first indication information is jointly encoded with a frequency domain resource assignment (FDRA) field in the first DCI;
the first indication information is jointly encoded with a time domain resource assignment (TDRA) field in the first DCI; or
the first indication information is jointly encoded with a bandwidth part index (BWP index) field in the first DCI.

11. The method according to claim 1, wherein the first DCI further carries second indication information, and the second indication information is used to instruct the terminal to switch the waveforms of the physical channels of the plurality of cells to a target waveform.

12. A terminal, comprising: a memory storing a computer program; and a processor coupled to the memory and configured to execute the computer program to perform operations comprising:
receiving, by the terminal, first downlink control information (DCI) from a network device, wherein the first DCI is used to schedule physical channels of a plurality of cells; and
using, by the terminal, pre-configured waveforms of the physical channels of the plurality of cells,
wherein when the first DCI is used to schedule the physical channels of the plurality of cells, the terminal does not support dynamic waveform switching.

13. The terminal according to claim 12, wherein the operations further comprise:
when the first DCI carries first indication information, switching, by the terminal based on the first indication information, waveforms of the physical channels of the plurality of cells according to a preset rule, wherein the preset rule is associated with an attribute of the plurality of cells,
wherein the attribute of the plurality of cells comprises one or more of the following:
a relationship among the plurality of cells on a frequency domain resource;
a frequency domain resource assignment manner of the physical channels of the plurality of cells;
a time domain resource assignment relationship of the physical channels of the plurality of cells;
a bandwidth part (BWP) in which the physical channels of the plurality of cells are located; or
whether the plurality of cells belong to a same timing advance group (TAG).

14. The terminal according to claim 13, wherein the operations further comprise:
when the plurality of cells comprise one or more cell groups, and intra-band carrier aggregation is used between a plurality of cells in each cell group, the switching, by the terminal based on the first indication information, waveforms of the physical channels of the plurality of cells according to a preset rule comprises one or more of the following:
switching, by the terminal based on the first indication information, waveforms of physical channels of all cells in the cell group to a same waveform, wherein the first indication information is used to indicate whether to switch waveforms of physical channels of different cells in the cell group; or
switching, by the terminal based on the first indication information, a waveform of a physical channel of a first cell in the cell group to the same as a waveform of a physical channel of a second cell in the cell group, wherein the first cell is a cell in the cell group except the second cell, and the first indication information is used to indicate whether to switch the waveform of the physical channel of the first cell.

15. The terminal according to claim 13, wherein when the plurality of cells comprise one or more cell groups, and inter-band carrier aggregation is used between a plurality of cells in each cell group, the switching, by the terminal based on the first indication information, waveforms of the physical channels of the plurality of cells according to a preset rule comprises one or more of the following:
when the plurality of cells comprise one cell group, independently determining, by the terminal based on the first indication information, whether to switch a waveform of a physical channel of each cell in the cell group, wherein the first indication information is used to indicate whether to switch waveforms of physical channels of different cells in the cell group; or
when the plurality of cells comprise a plurality of cell groups, separately switching, by the terminal based on the first indication information, waveforms of physical channels of all cells in each cell group, wherein the first indication information is used to indicate whether to switch waveforms of physical channels of all cells in different cell groups.

16. The terminal according to claim 13, wherein when the plurality of cells comprise a plurality of cell groups, intra-band carrier aggregation is used between a plurality of cells in each cell group, and cells between the cell groups are in an inter-band relationship, the switching, by the terminal based on the first indication information, waveforms of the physical channels of the plurality of cells according to a preset rule comprises:
separately switching, by the terminal based on the first indication information, waveforms of physical channels of all cells in each cell group to a same waveform, wherein the first indication information is used to indicate whether to switch waveforms of physical channels of all cells in different cell groups to a same waveform, and first indication information corresponding to each cell group is independently configured.

17. The terminal according to claim 13, wherein when the plurality of cells belong to a same TAG, the switching, by the terminal based on the first indication information, waveforms of the physical channels of the plurality of cells according to a preset rule comprises one or more of the following:
switching, by the terminal based on the first indication information, waveforms of physical channels of all cells in the cell group to a same waveform, wherein the first indication information is used to indicate whether to switch waveforms of physical channels of different cells in the cell group; or
switching, by the terminal based on the first indication information, a waveform of a physical channel of a first cell in the cell group to the same as a waveform of a physical channel of a second cell in the cell group, wherein the first cell is a cell in the cell group except the second cell, and the first indication information is used to indicate whether to switch the waveform of the physical channel of the first cell.

18. The terminal according to claim 13, wherein when the plurality of cells comprise one or more cell groups, and a plurality of cells in each cell group belong to a same TAG, the switching, by the terminal based on the first indication information, waveforms of the physical channels of the plurality of cells according to a preset rule comprises one or more of the following:
when the plurality of cells comprise one cell group, independently determining, by the terminal based on the first indication information, whether to switch a waveform of a physical channel of each cell in the cell group, wherein the first indication information is used to indicate whether to switch waveforms of physical channels of different cells in the cell group; or
when the plurality of cells comprise a plurality of cell groups, separately switching, by the terminal based on the first indication information, waveforms of physical channels of all cells in each cell group, wherein the first indication information is used to separately indicate whether to switch waveforms of physical channels of all cells in different cell groups.

19. The terminal according to claim 13, wherein when the plurality of cells comprise a plurality of cell groups, a plurality of cells in each cell group belong to a same TAG, and cells between the cell groups belong to diffident TAGs, the switching, by the terminal based on the first indication information, waveforms of the physical channels of the plurality of cells according to a preset rule comprises:
separately switching, by the terminal based on the first indication information, waveforms of physical channels of all cells in each cell group to a same waveform respectively, wherein the first indication information is used to separately indicate whether to switch waveforms of physical channels of all cells in different cell groups to a same waveform, and first indication information corresponding to each cell group is independently configured.

20. A chip, comprising a processor and a communication interface, wherein the communication interface is coupled to the processor, and the processor is configured to run programs or instructions to cause a terminal to perform operations comprising:
receiving, by the terminal, first downlink control information (DCI) from a network device, wherein the first DCI is used to schedule physical channels of a plurality of cells; and
using, by the terminal, pre-configured waveforms of the physical channels of the plurality of cells,
wherein when the first DCI is used to schedule the physical channels of the plurality of cells, the terminal does not support dynamic waveform switching.
